(19) United States
(12) Patent Application Publication
(10) Pub. No.: US 2014/0249969 A1
(43) Pub. Date: Sep. 4, 2014

(54) Method for item or service recommendation based upon performance of user with item or service.

(71) Applicant: PAUPT LABS LLC, Mount Kisco, NY (US)

(72) Inventors: Daniel Alexander Ford, Mount Kisco, NY (US); Caldwell Martin Toll, II, Chappaqua, NY (US)

(73) Assignee: PAUPT LABS LLC, Mount Kisco, NY (US)

(21) Appl. No.: 13/781,998

(22) Filed: Mar. 1, 2013

(51) Int. Cl. G06Q 30/06

(52) U.S. Cl. CPC G06Q 30/0643
USPC 705/27.2

(57) ABSTRACT

A method, system and computer program for producing endorsements for products or services that have indisputable documentation of successful the product or service's successful use by a user in an activity.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The field of the invention relates to methods for creating user interfaces in an electronic commerce web site, and more particularly, to methods, systems and computer programs for creating endorsements in an electronic commerce web site.

2. Description

A common product marketing technique is to associate products or services for sale with endorsements by well known people such as celebrities and athletes. The intent of this practice is to build an association between the product, and the endorser, such that the credibility of the endorser is transferred to the product, enticing customers to buy. The value of this transfer is contingent on the subjective credibility that the endorser, and their endorsements, have with the customer, a fickle point at best.

Recently, online merchant web sites have provided mechanisms for associating the products they sell with endorsements or ratings provided by “ordinary” people (i.e., non-celebrities). These are displayed together with the product as part of the user interface presented to customers for product sales. These endorsements are manually created, and have little external qualitative basis for their credibility. This leaves customers with the task of evaluating the credibility of the endorsement with little factual information other than the content of an unknown person's subjective opinion. This lack of obvious credibility is a competitive issue for online merchants as they search for ways to better serve their customers, and increase their sales.

The problem to be solved is to develop a method for online merchants to create product endorsements that will be accepted as indisputably credible by their customers. The features of a good solution to this problem will include a significant degree of automation, and require little direct human input or management. These traits will allow a wide range of products and services to be associated automatically with credible endorsements at minimal cost.

The basic idea of providing some kind of product recommendation to a customer by an online merchant is discussed by Kane et al, U.S. Pat. No. 7,881,984, entitled “Service for providing item recommendations,” issued Feb. 1, 2011. The patent discloses a system “for enabling web sites and other entities to provide item recommendations” that are based upon associations between various items, such as two items being purchased together by other customers. This approach is deficient as a solution as it does not provide an indisputably credible endorsement recognizable to a customer, it simply associates a product that was purchased concomitant with the one being displayed, making the association more of a recommendation to also purchase the other product, rather than an endorsement of the one being displayed.

A common thread in previous attempts by online merchants to provide endorsements is the inclusion of manually generated endorsement statements. Such a statement may take the form of actual words, or, alternatively, some other kind of indication of “ranking” or “like” of the product or service by the endorser; for instance, someone might rate the quality of a product as “four out of five stars.”

A point of variation in previous approaches is the source of such manually produced endorsements. The approach of extracting, managing, propagating and presenting manually created endorsements from social networks is an area that has been explored and disclosed. An example is Klish, U.S. Publication No. US2010/0223119, entitled “Advertising Through Product Endorsements in Social Networks,” published Sep. 2, 2010. Another example is Korte et al, U.S. Pat. No. 7,827,176, entitled “Methods and systems for endorsing local search results,” issued Nov. 2, 2010. Purvy et al, Publication No. US2011/0258042, entitled “Endorsements Used in Ranking Ads,” published Oct. 20, 2011, and Schoen, U.S. Publication No. US2012/0232998, entitled “Selecting social endorsement information for an advertisement for display to a viewing user,” published Sep. 13, 2012, both teach how endorsements provided by users of a social network can be ranked by the relationships, and associations, between users in the network, such that endorsements from friends are ranked higher than those from non-friends. Badros et al, U.S. Publication No. US2012/0084160, entitled “Providing Social Endorsements with Online Advertising,” published Apr. 5, 2012, teaches how to extract endorsements from social networks from “users related to the viewing user.” Similarly, Berman et al, U.S. Pat. No. 8,095,432, issued Jan. 10, 2012, entitled “Recommendation engine for social networks,” discloses methods and systems for ranking recommendations based on “relationship proximity,” such that they are displayed in order of rank. Lifson, U.S. Pat. No. 7,756,756, entitled “System and method of providing recommendations,” issued Jul. 13, 2010, describes how to query a user/customer of an online merchant to obtain the contact information of their friends to solicit recommendations. These approaches are deficient as solutions as they do not create endorsements with indisputable credibility. A comment about a product from a friend might be accepted as a positive recommendation, or, depending upon the customer's own subjective opinion of the “friend's” credibility, it might well be considered to be negative. Subjective opinion cannot be anticipated or controlled by the merchant; the use of a friend extracted from a social network is an imperfect attempt to improve the odds of a credible positive association in the mind of the potential customer.

The idea of developing an online marketplace for endorsement transactions is disclosed in Wu et al, U.S. Pat. No. 8,219,492, entitled “System and method for internet marketing by endorsements,” issued Jul. 10, 2012, discloses methods and systems for creating and managing an online marketplace for the solicitation and fulfillment of endorsements. This approach is deficient in that it does not address the credibility of the endorsements available, it simply provides a venue for exchanging endorsements without any regard to their nature or quality.

Klinger et al, U.S. Publication No. 2009/0271289, entitled “System and method for propagating endorsements,” published Oct. 29, 2009, discusses an approach to storing and transfering existing manually generated endorsements. Similarly, this approach is deficient in that it does not address the creation or credibility of the endorsements it propagates.

### BRIEF SUMMARY OF THE INVENTION

This invention teaches a method for online merchants to create indisputably credible, non-subjective, product endorsements by documenting a direct association between the product and actual successful use of the product.

The idea behind the invention is that rather than use an endorsement that says that a particular person likes a product, one should instead create a type of factual endorsement that specifically documents that the product was part of someone's success. For instance, if the product is a particular kind of running shoe, the invention could generate an endorsement that documents that that exact brand and model of shoe was worn by a person, or persons, who actually won a race, and also documents the exact race(s) so won. This solution eliminates the subjective nature of evaluating an endorsement's credibility by using documented, indisputable, facts. The customer can then decide if the facts warrant the purchase of the product.

### BRIEF DESCRIPTION OF THE SEVERAL VIEWS OF THE DRAWING

FIG. 1. Illustrates an overview of the inventive system architecture.

FIG. 2. Illustrates a flow diagram for the processing required to generate a product presentation page that includes a success documenting summary of people or entities who use the product.

FIG. 3. Illustrates a flow diagram for the processing required to generate a success documenting summary of people or entities who use a product.

FIG. 4. Illustrates an example of a web page that presents a product for sale along with an inset that documents the successful performance of a single person (a Fashion Model).

FIG. 5. Illustrates an example of a web page that presents a product for sale along with an inset that documents the successful performance of an aggregation of three people (three Fashion Models).

FIG. 6. Illustrates an example of a web page that presents a product for sale along with an inset that documents the successful performance of an abstract entity (a basketball team).

FIG. 7. Illustrates an example of a web page that presents a product for sale along with an inset that documents the successful performance of an inanimate object (an automobile).

FIG. 8. Illustrates an example of a web page that presents a product (recorded music) that can be acquired without a purchase, along with an inset that documents the successful performance of a single person (a runner).

### DETAILED DESCRIPTION OF THE INVENTION

While this invention is illustrated and described in a preferred exemplary embodiment, the invention may be produced in many different configurations, forms and materials. There is depicted in the drawings, and will herein be described in detail, a preferred exemplary embodiment of the invention, with the understanding that the present disclosure is to be considered as an exemplification of the principles of the invention, and the associated functional specifications of the materials for its construction, and is not intended to limit the invention to the embodiment illustrated. Those skilled in the art will envision many other possible variations within the scope of the present invention.

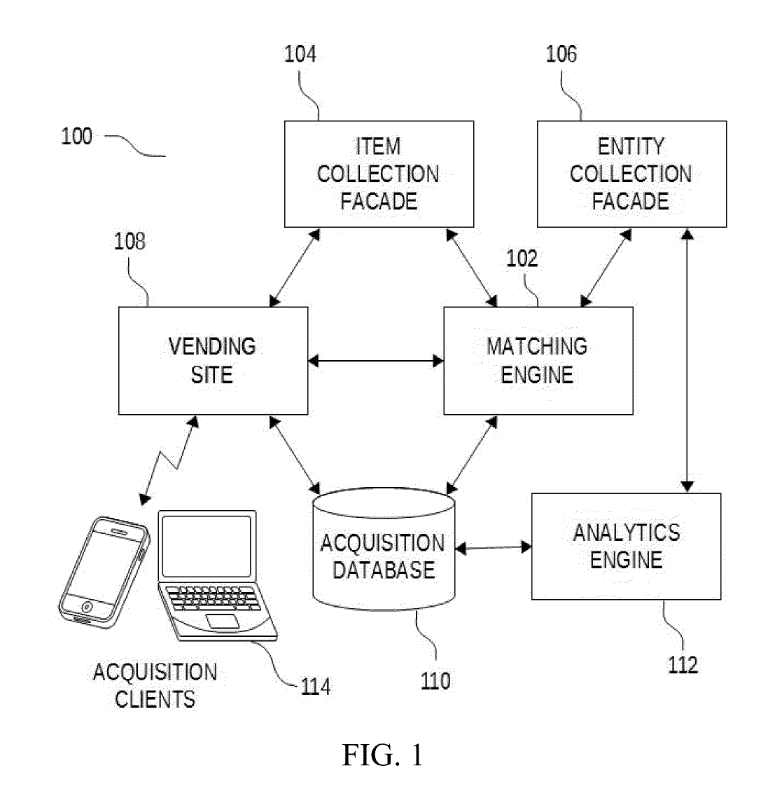

Referring now to the drawings, FIG. 1, illustrates a schematic overview of the inventive system architecture 100. The system consists of a Matching Engine 102, an Item Collection Facade 104, an Entity Collection Facade 106, a Vending Site 108, an Acquisition Database 110, an Analytics Engine 112, and one or more Acquisition Clients 114. The lines between the components illustrated in the inventive system architecture 100 represent inter-component communications channels, which in this preferred exemplary embodiment are implemented using Message Oriented Middleware such as the Java Messaging Service (JMS). The exception to this, is the technology used to communicate between the Vending Site 108 and Acquisition Clients 114; in that case, the communication means is the Hypertext Transfer Protocol (HTTP).

The advantage of using message passing in the inventive system is that it decouples the implementation, and deployment, details of the system's components such that component inter-dependencies are reduced; this, in turn, enables greater scalability of the entire systems, by allowing the possibility of multiple instances (not illustrated) of the system's components to be run, in parallel, on different computers. A message passing architecture, is a well known design pattern, frequently encountered by one skilled in the art, for implementing scalable, “Enterprise Level,” systems.

In one of many other possible alternative embodiments, the communications between the components could be implemented using simple subroutine calls, or by using “direct” network connection, with a standard or proprietary protocol, that avoids the use of a Middleware layer; these and other approaches are well known to one skilled in the art.

In one of many other possible embodiments, the communications technology used between the Acquisition Clients 114 and the rest of the system need not be limited to HTTP, but instead could be other protocols, standard or proprietary, or even other methods, including electronic mail.

The Matching Engine 102, serves as the central core of the inventive system, and is responsible for matching products or services for sale with people, or entities, who use the particular product or service, and subsequently generating a success documenting summary of those users being successful in some activity while using the product or service.

The Matching Engine 102, functions by waiting for a message to arrive with a request for a success documenting summary. This message includes information about the identity of the requester sufficient to direct a reply, and becomes the trigger for the Matching Engine 102 to produce such documentation. The success documenting summary contains sufficient information to create a depiction of the user(s) that includes information that documents the user's success. When the Matching Engine 102 has created such a success documenting summary, it generates a reply message, adds the summary, and sends the message back to the original requester.

In one of many other possible alternative embodiments, the concepts of a product or service, and its successful users, can both be greatly generalized. A product could be any physical object or virtual item, or a service, and a successful user could be any type of entity capable of using the item or service. For instance, an item could be a book, a cosmetic, or a consumable such as a meal selected from a menu, or, the item could be digital content such as music, video, photographs, images, text, books, games, a contest entry, audio, computer programs, models, designs, patterns, waveforms, diagrams, menus, icons, maps, directions, or any other digitally representable information. A service is something that is provided, typically, but not exclusively, for a fee, such as a haircut or a house cleaning An entity would frequently be a single person, but a generalization of the concept also includes aggregate groups of people such as sports teams, as well as abstractions such as corporations or inanimate objects (e.g., an automobile). For example, matching a particular brand of sports shoe with a championship winning basketball team whose players all wore that specific shoe in the championship game, or matching a specific type of an automobile tire with a race winning automobile that actually used that specific tire when it won the race. This type of generalization of successful people to successful entities would be easily understood and accomplished by one skilled in the art.

In this preferred exemplary embodiment, the concept of “successfully outperforming” means that a person has surpassed one or more other people in some activity. An example is a Fashion Model being voted the “Best model of New York Fashion Week,” meaning that she successfully “outperformed” all the other Fashion Models at the same event, or it could be something as simple as a person winning their local foot race, thus successfully outperforming the other runners. This concept is also subject to extensive generalization in many other possible alternative embodiments.

In one of many alternate embodiments, successfully outperforming could be a relative measure that captures the idea of “most improved,” meaning that someone may not have “won the race,” but in comparison to one's previous performance, they were the ones that recorded an improvement, relative to themselves, that was better than the improvement of anyone else, relative to themselves. An example would be in an exercise that tracked individual weight loss among a set of dieters, one person may have lost the most weight, but another might have lost the most weight relative to their original weight, the later having out performed the former in relative terms.

The Item Collection Facade 104 is responsible for encapsulating the implementation details of accessing collections of products and services to be purchased. It uses the Facade design pattern, well known to one skilled in the art, to provide an abstract interface to such collections. This approach shields the other system components in the inventive system architecture 100, such as the Matching Engine 102, from any dependencies on the exact nature or number of collections of products or services managed and accessed by the Item Collection Facade 104, or on any of the Item Collection Facade's 104 internal implementation details. This is a design feature of the preferred exemplary embodiment that makes it easier to extend and adapt it to access virtually any number or type of such collections, without unduly impacting the other system components.

The processing implemented by the Item Collection Facade 104 includes querying one or more relational databases using SQL, and, or, one or more NoSQL databases using implementation specific query protocols. The facility of being able to add extensions of the system to incorporate other data sources, ones with other access methods, is a deliberate design feature of the inventive system 100. The adaption and integration of such sources, and making access to them available through a message passing interface, is a common development activity that would be familiar, and well within the capabilities, of one skilled in the art.

The Entity Collection Facade 106 is designed in a similar manner to that of the Item Collection Facade 104. It encapsulates the implementation details of accessing collections of people. Like the Item Collection Facade 104, the Entity Collection Facade 106 is designed using the Facade design pattern, and provides an abstract interface to such collections, available through message passing communication channels. Again, this approach simplifies the design and implementation of the system by shielding the other components in the inventive system 100 from the number and nature of the entity sources being accessed. In the preferred exemplary embodiment, the source would be a conventional relational database.

In one of many alternate embodiments, these entity sources could include social networks, databases, online games, or real-time data sources. Techniques for interfacing with such collections, and extracting personal, performance, and product association information from them are known to one skilled in the art.

The Entity Collection Facade 106 also serves to funnel compensation to people and entities participating in the system to motivate their continued engagement. It receives messages from the Analytics Engine 112 detailing such compensation and facilitates the transfer of funds or other rewards to the participants in accordance with providing them with compensation.

The functions performed by the Item Collection Facade 106, and the Entity Collection Facade 104, could be implemented differently in many alternative embodiments. The main point of their function is to provide access to collections of products and collections of people who use the products successfully, and to encapsulate the necessary interfacing details which will vary from collection-to-collection. Providing alternative approaches to such access would be easily implemented by someone skilled in the art.

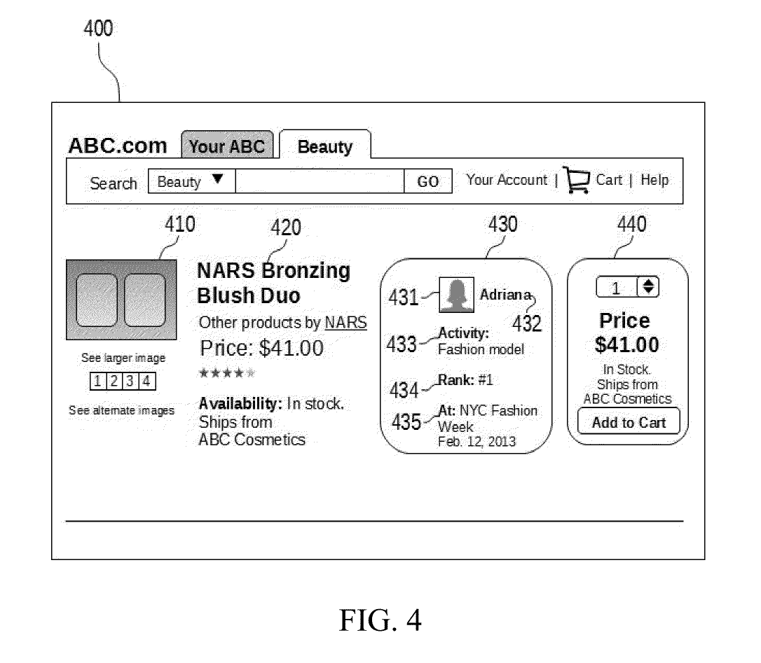

The Vending Site 108 is responsible for providing a client interface and requisite functionality for vending (selling) products such that the products can be purchased by customers. A fundamental function of the Vending Site 108 is to provide a suitable customer interface that combines representations of the product being sold in conjunction with indisputable endorsements, the contents of which are provided in the success documenting summaries provided by the Matching Engine 102, of people or entities who use the product successfully. The example web page in diagram 400, FIG. 4, illustrates an example of such a user interface as it might be rendered in a Web browser.

The other fundamental function of the Vending Site 108 is to provide a means for the customer to purchase the product or service.

In one of many possible alternative embodiments the Vending Site 108 can be much more abstract in how it provides products to customers. The Vending Site 108 can be less of a sales vehicle, and more of a point of acquisition such as a “download site” for things such as music or video.

In one of many possible alternate embodiments, acquisition of an item would not necessarily involve an actual sale or financial transaction by a customer. The mode of acquisition could be gifting or donation, or simply a free giveaway.

The Acquisition Database 110 serves to record the details of which products and services, were presented, in conjunction with success documenting summaries of successful people, by the Vending Site 108, and whether the combination resulted in a customer actually purchasing the product or service, or not. It, too, is implement using a message passing interface. The details of how it records the data, and processes the queries, it receives are encapsulated within the component 110, in a similar manner, and for the same motivations, as the implementations of both the Item Collection Facade 104, and the Entity Collection Facade 106. Typically, that processing would include querying one or more relational databases using SQL, and, or, one or more NoSQL databases using implementation specific query protocols. The purpose of this record is to support the processing of queries from the Matching Engine 102, and analytic processing by the Analytics Engine 112, and to support the compensation of people (entities) participating in the system.

The Analytics Engine 112 is responsible for determining the effectiveness of the success documenting summaries being produced by the Matching Engine 102. For each product recorded in the Acquisition Database 110, the Analytics Engine 112 ranks the matches between the product and summaries that result in actual sales of the product. These rankings are then stored back in the Acquisition Database 110 for reference by the Matching Engine 102, and any other future components, such as report generators or any other type of post processor easily envisioned by one skilled in the art.

In addition to its processing of the sales records, the Analytics Engine 112 also computes the compensation due to people participating in the system. It sends that information to the Entity Collections Facade 106 so that compensation can be passed along to the participants.

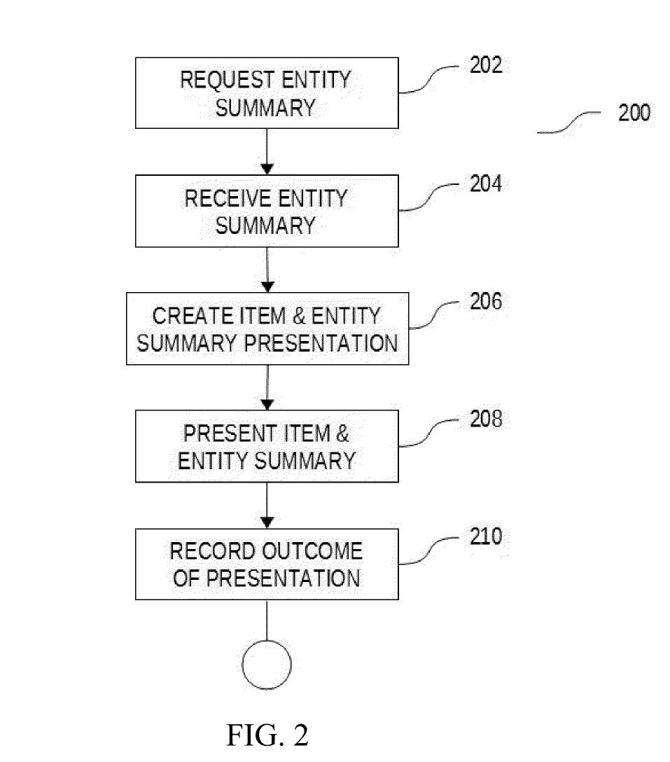

Referring to FIG. 2, a flow diagram 200 illustrates steps for the Vending Site 108, FIG. 1, to obtain success documenting summaries of users of a product or service that can be displayed together with the product or service when presented to potential purchasers. The basic intuition behind the flow diagram is that it details how the Vending Site 108 issues its request to the Matching Engine 102 asking it to generate and return a success documenting summary, and then how it processes the summary response to create a presentation that associates the product with the summary.

In step 202, in FIG. 2, the Vending Site 108 first issues a request for a success documenting summary of people who successfully use a product. As discussed above, in this preferred exemplary embodiment, this request would be made by sending a message to the Matching Engine 102 using Message Oriented Middleware such as the Java Message Service. This message includes the Stock Keeping Unit (SKU) of the product, and, if known, information about the potential customer. The customer information can include their age, sex, and where they reside.

In one of many other possible alternative embodiments, the product could be uniquely identified by data other than a SKU, and in fact, different identification technologies could be combined to accommodate established standards for particular types of products or services. Techniques for accommodating, and disambiguating, such variety in identification approaches would be well known to those skilled in the art.

In one of many potential alternative embodiments, the customer information could be much more extensive, and include, but not be limited to, geographic preferences, income levels, abstract categorizations (e.g., “baseball fan”), race, religious affiliations, social connections, or sexual preferences. This list could easily be incorporated into the information contained in the message sent in step 202 by one skilled in the art. It would also be obvious to one skilled in the art, that different additional customer related information could be added to the user success documenting summary. For instance, if the product was a particular type of cosmetic (e.g., “blush”), the summary request might identify the customer as a young, single, white female with red hair, who lives in the San Francisco Bay area, and makes more than $100,000 a year. Incorporating such detail into the processing of the Matching Engine 102 would be well within the capabilities of one skilled in the art.

In step 204, the Vending Site 108 waits to receive a response to the request it made in step 202. This response is contained in a message sent by the Matching Engine 102, and includes, if available, a success documenting summary of a person or entity who uses the particular product or service specified in the original message sent in step 202. It is possible that the Matching Engine 102 could not find any appropriate users of the product (e.g., they don't exist or are otherwise not in accordance with the request), in which case the return message would indicate such. If, however, an appropriate person or entity was found, the response message would also include information for producing depictions of such. Some of this information, for instance, would include textual details such as their name and age, and be directly embedded in the message; any available images, or even video, of the person would be represented as a URL, to a source from which the data for the image can be retrieved.

In one of many possible alternative embodiments, the reply message could include more or less information in the messages depending on design tradeoffs made for different implementation environments. These trade-offs would depend upon the exact implementation details regarding performance requirements, cost, time and other factors that would be easily accommodated by one skilled in the art.

In step 206, the Vending Site 108 combines the information extracted from the response message it received in step 204, with similar information detailing the product being presented to the customer (e.g., images, video, etc.), to create a combined presentation that displays both a depiction of the product, and depictions of the entities in the endorsement. An example of such a combined presentation is illustrated in an example web page 400, FIG. 4. It shows an outline of a web page that offers a particular type of cosmetic (“blush”) for sale. The page includes an image of the product 410, its name 420, and two insets 430 and 440, one that displays the result of a success documenting summary response representing a single person 430, and the other 440 providing a means to purchase the product. The product purchase inset illustrates functionality that has been a common feature of online merchant web sites for many years; techniques for its implementation are well known to one skilled in the art.

The endorsement inset 430, includes an image of a fashion model 431, her name “Adriana” 432, the name of the activity in which she successfully outperforms others 433 (“Fashion Model”), her rank in a particular activity event 434, and the event 435 in which she was ranked 435, “NYC Fashion Week” (a large fashion event held regularly in New York City).

The use of an inset to highlight parts of the presentation is a cosmetic visual design decision that in no way is intended to restrict the nature of the presentations that associate products with indisputable endorsements. One of many possible alternate embodiments might remove the inset frame, or arrange the endorsement information to appear in a different location, or for it to be partitioned and placed in multiple separate locations.

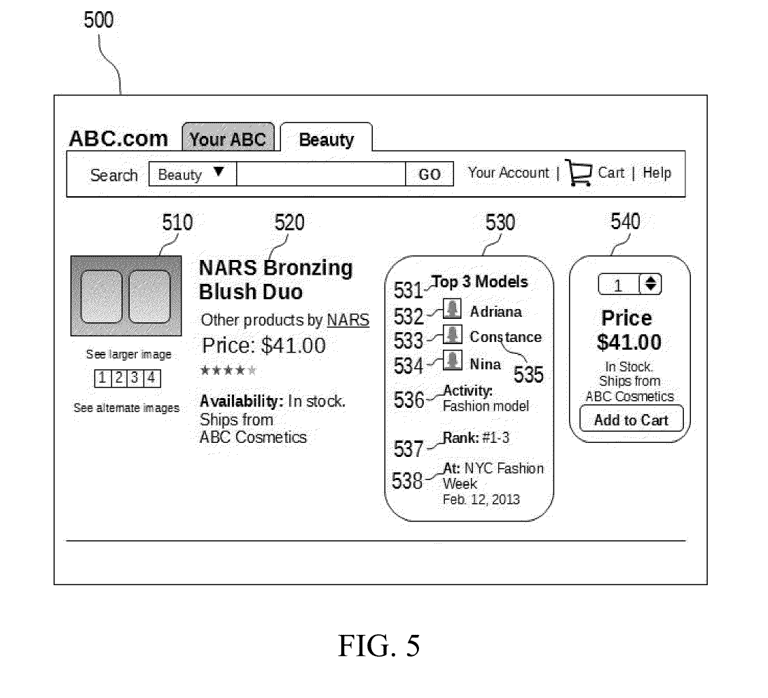

The example web page 500, FIG. 5, illustrates a similar example as in 400, FIG. 4. The product being sold in 500 is the same as in 400, so the product images 510, and 410, and names 520, and 420, respectively, are the same, as is the means to purchase 540 and 440. The difference, is that in 500, the inset 530 displays an example of an aggregate success documenting summary of three Fashion Models instead of just one. This includes a title 531, that indicates that the product is used by the “Top 3 Models” at the event 538. Photos of the three models 532, 533, 534, are included, along with their associated names, for example, the photo 533 with the name “Constance” 535. The success documenting summary also includes a description of the activity 536, the rankings 537 of the three models (1, 2, 3), and the event in which they successfully outperformed others 538. Of course the use of specifically three models in this example is just for illustrative purposes, the actual number of aggregated entities in a success documenting summary is a design decision that could vary from one implementation to another, and from one summary to another.

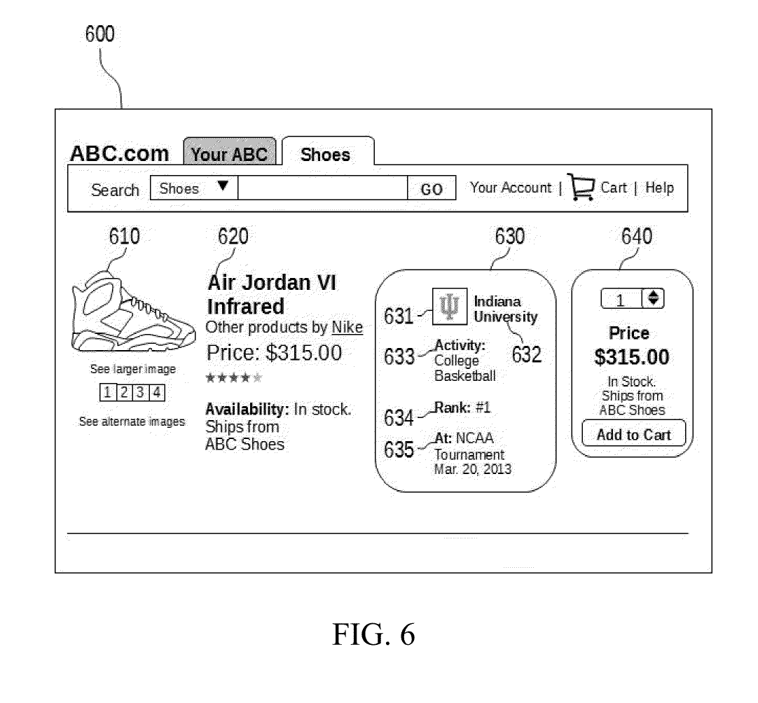

The example web page 600, FIG. 6, illustrates the presentation of a type of basketball shoe for sale. As in the previous example web pages, 500 and 400, it includes a product image 610, and product name 620, and a means to purchase 640; the difference, is the success documenting summary inset 630 displays a summary of an abstract entity (a basketball team). The summary includes an image of the team's emblem 631, its name 632, the activity it successfully outperforms others in 633 (“College Basketball”), its rank in a particular event 634, and the particular event in which it successfully outperformed others, (“NCAA Tournament”).

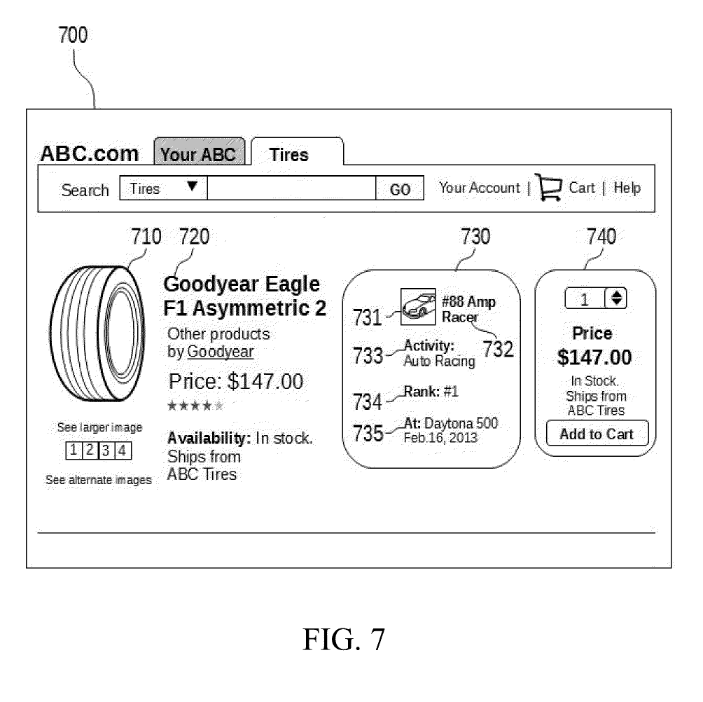

The example web page 700, FIG. 7, illustrates the presentation of a type of a particular model and brand of automobile tire for sale. As with the previous example web pages 400, FIG. 4, 500, FIG. 5, and 600, FIG. 6, the example web page 700 includes a product image 710, it's name 720, and means to purchase the product 740. The success documenting summary inset 730 however is different in that it documents an inanimate object that uses the product, in this case, an automobile. The inset 730, includes an image of the automobile 731, its “name” 732, the activity in which it successfully outperformed others 733, the rank it achieved in an event 734, and the particular event in which it was successful.

In one of many possible alternative embodiments, the products, and success documenting summaries, and how they are associated could be presented in a manner other than a web page, such as in the interface of program like an application for mobile smart phone. They could also be presented non-visually such as in accordance with an audio description.

In one of many alternative embodiments, the success documenting summaries could include different types of entities, including mixed types (e.g., people and objects, people and teams, teams and objects, etc.).

In one of many alternative embodiments, depictions of the products or services, and entities in the success documenting summaries could include different information, including more or less detail, as well as video, animation, audio, multimedia, data, statistics, rankings, or descriptions.

In one of many alternative embodiments, the success documenting summaries could be much more general, meaning that instead of identifying a specific event, in which an entity successfully outperformed another, the measure could be something like “highest earning,” meaning that the entity earned the most amount of money in a particular year, likely participating in a variety of different events (e.g., professional tennis matches), but earning the most in a calendar year, for example.

In one of many alternative embodiments, the success documenting summaries could be generated such that the product, the service, the potential customer, or with the people or entities who use the product successfully, or all of the aforementioned candidates for association, are associated with a defined geographic area. For example, if the potential customer is located in a particular city, then a successful entity that uses the product, in the same city, might be selected for the summary rather than a roughly equivalent entity who is equally (or even more) successful, but lives in a different city. The opposite is also possible, selecting successful entities who are from a different location than the customer. The idea in that case would be to present successful users from places that the customer might consider to be more “sophisticated” than where they live, and thus harder to succeed, making a success documenting endorsement that much more credible with the customer (“If they can make it there, they must be good.”) . The success documenting inset 430 in the example web page 400, FIG. 4, includes a geographic designation 435 that identifies a location (“NYC” short for New York City) as part of the endorsement; a similar designation 538 is part of the corresponding inset 530 in the example web page 500, FIG. 5. Such an endorsement might be targeted at a customer who lives in a small town far away from New York.

Similarly, in one of many alternative embodiments, the success documenting summaries could be generated according to an abstract classification associated with either the product, the service, the potential customer, or with the entities in the summary, or all of the aforementioned abstract classification candidates. For example, if the potential customer is a fan of a particular basketball team, then the successful entity that might be selected could be another fan of the same basketball team, or even the basketball team itself. If the option of using another fan of the same team is selected, then their status of also being a fan would be part of the success documenting summary.

In one of many alternative embodiments, the presentation of the “product” may not include a requirement to actually purchase the product in order for the “customer” to acquire it. In this scenario, the Vending Site 108, FIG. 1, plays more of a role of a “free download” site than that of a “for profit” online merchant.

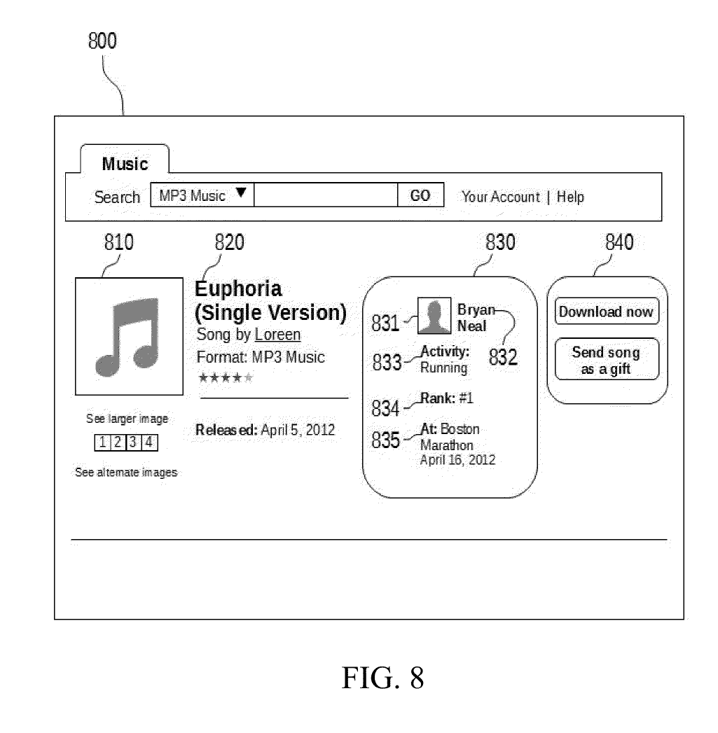

The example web page 800, FIG. 8, illustrates the presentation of music that can be downloaded without completing a financial transaction. The visual presentation includes an image appropriate for the music 810 (e.g., album cover art), a title, and description 820, an inset for the entity who uses the music while successfully outperforming others 830, and an inset for initiating acquisition 840. The entity inset 830, contains an image 831, name 832, activity 833, rank 834, and event information 835; in this example, the presentation associates the music with a successful runner in accordance with the runner listening to the music while running in, and winning (i.e., successfully outperforming others) the indicated race 835. The acquisition inset 840 offers two choices for acquiring the song 820. It can be downloaded by transferring it from a computer accessible storage device accessible to the Vending Site 108 to a computer accessible storage device accessible to the acquirer (i.e., the “customer”). Or, alternatively, it can be sent as a “gift” to another entity; the transmission of the gift can be implement in many ways known to those skilled in the art, with one, of many, options being sending it, or a link (e.g., URL) via electronic mail.

In step 208, the presentation created in step 206 is made available to the potential customer through their Acquisition Client 114. This is represented in the schematic overview of the inventive system architecture 100, FIG. 1, as either a computer or smart phone. The intent of those representations is meant to be illustrative, not restrictive, as many options exist.

In one of many other possible alternative embodiments, many other kinds of devices and technologies could be used as an Acquisition Client 114. For instance, a customer might use a special type of wristwatch, or an augmented reality display, the device could even simply render audio descriptions. The point is that the Acquisition Client 114 is whatever a customer would use to make a purchase from a Vending Site 108, such that it is capable of providing some representation of a product and the indisputable endorsement.

In step 210, the outcome of the customer's purchase decision from step 208, is recorded by the Vending Site 108 in the Acquisition Database 110. This record includes the SKU of the product presented for purchase, a customer identifier, if known, and success documenting summary identifier, if such a summary was presented.

In one of many other alternative embodiments, the exact details of what is recorded in the Acquisition Database 110 could vary considerably depending upon the implementation design decisions made by one skilled in the art to adapt the system to implementation dependent requirements.

After step 210, processing of the display of one product or service for sale is effectively complete for the Vending Site 108. Processing flow would then resume with step 202 for the presentation of yet another product or service for sale to the same or a different potential customer. The basic idea is that as a customer browses through the offerings of an online merchant web site, the production of the product web pages would follow the processing flow outlined in the flow diagram 200, FIG. 2.

In one of many other possible alternative embodiments, the exact processing flow could vary, and one skilled in the art would have few problems producing alternatives, but the intent would remain the same, to associate the product for sale with an indisputable endorsement.

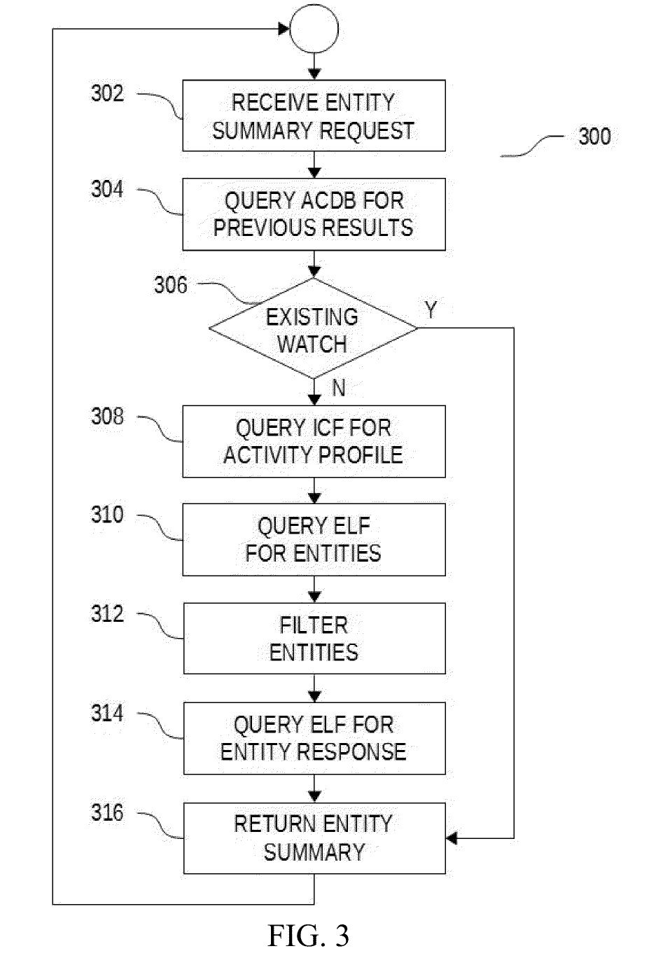

Referring FIG. 3, a flow diagram 300 illustrates steps for the Matching Engine 102 to process success documenting summary requests from the Vending Site 108. In this preferred exemplary embodiment, these requests arrive via the previously mentioned Message Oriented Middleware, and are sent by the Vending Site 108 in step 202 in the flow diagram 200, FIG. 2. The intuition behind the processing flow is that the Matching Engine 102 waits to receive a message with a request, and then when it receives one, it processes it, generates an appropriate response, and then returns that response to the requester. Processing beings in step 302, where the Matching Engine 102 waits until it receives a request from the Vending Site 108; when such a message arrives, processing flow proceeds to step 304.

In step 304, the Matching Engine 102 extracts the details of the request and prepares a query for the Acquisition Database 110 (labeled “ACDB” in 1304) to retrieve acquisition records for previous success documenting summary requests for the product specified in the message received in step 302. This query is then issued to the Acquisition Database 110, and the results retrieved.

In step 306, the Matching Engine 102 examines the results returned by the Acquisition Database 110, and determines if an existing match is found, and, if so, if it should use the existing match, if any. If the answer is “no,” processing flow proceeds to step 308, if “yes,” then processing flow proceeds to step 316.

In step 308, the Matching Engine 102 queries the Item Collection Facade 104 for details of the product specified in the request, in particular, it retrieves specifics on the activity, or activities, in which the product is used.

In step 310, the activity details retrieved in step 308, along with other customer details (e.g., demographics, etc.) are then combined and used to query the Entity Collection Facade 106 for people who both use the specific product, and who successfully outperform other people in one or more of the activities in which the product is used. For example, if the item was a cosmetic such as “blush,” the Entity Collection Facade 106 might be queried for users of that exact cosmetic who are the same age as the customer, and who have recently won a beauty contest or similar event.

In step 312, the results of the query issued in step 310 are processed to produce the most appropriate response, which could include filtering out some of the people contained in the query results. So, if there is only a single result from the query, then processing flow proceeds directly to step 314, but potentially, the query results may contain a large number of people to include in the success documenting summary. In that case, the Matching Engine 102 needs to pare the number down to produce a meaningful summary. If so, the Matching Engine 102 performs additional processing in step 312 to either select a single “best” person or entity to highlight in the summary, or to produce an aggregate success documenting summary that highlights a number of people or entities who successfully outperform others in the activity. For instance, the success documenting summary could indicate that the three top finishers in a beauty contest used a particular brand of “blush” like in the example web page 500, FIG. 5. Once this is accomplished, processing flow proceeds to step 314.

In one of many possible alternative embodiments, the success documenting summary could contain multiple, non-aggregated entities such that a number of different, but largely equivalent, entities might be displayed together.

In step 314, the Matching Engine 102 uses the success documenting summary generated in step 312 to prepare and issue another query to the Entity Collection Facade 106, this time to retrieve representation information for the people highlighted in the summary. A design feature of this preferred exemplary embodiment is an inherent flexibility in its ability to interface with, and access, a wide variety of data sources, including external sources not directly part of its implementation. This means that the nature and quality of the information available to represent a person will heavily depend upon the actual data sources so interfaced. At a minimum, the names of people and their achievement(s) would be expected, but images and video, or links to such, would be very desirable. One skilled in the art would have the necessary skills to implement such interfaces and provide data in accordance with the objectives of fulfilling the request. Once the query response was received and processed, processing flow would proceed to step 316.

In step 316, the Matching Engine 102 returns the success documenting summary produced in step 314 back to the Vending Site 108, where it is received in step 204, flow diagram 200, FIG. 2.

The Analytics Engine 112 operates by extracting information from the Acquisition Database 110, and performing mathematical analytic processing steps on it to produce results that characterize the effectiveness of the Matching Engine 102 in producing success documenting summaries that result in actual product or service sales. It also performs mathematical operations to analyze and summarize the participation of people and entities such that their participation can be compensated. This compensation summary information is forwarded to the Entity Collection Facade 106 to be resolved by it.

In this preferred exemplary embodiment, the interface between the Analytics Engine 112 and the Acquisition Database 110 is via message passing. In one of many possible alternative embodiments, the interface would be through a direct network connection. An example of which is that type of interface provided by the database MySQL, another example is the network interface provided by the NoSQL database MongoDB. The details of how to implement such an interface are well known to one skilled in the art.

A system and method has been shown in the above embodiments for the effective implementation of an electronic system to create product endorsements with indisputable credibility by documenting the success of users of the product or service in an activity, and then displaying that documentation in conjunction with the products or services for sale. While various embodiments have been shown and described, it will be understood that there is no intent to limit the invention by such disclosure, but rather, it is intended to cover all modifications and alternative constructions falling within the spirit and scope of the invention, as defined in the appended claims. For example, the present invention should not be limited by software/program computing environment, specific computing hardware. In addition the specific chosen computation methods are representative of the preferred exemplary embodiment and should not limit the scope of the invention.

The present invention can be implemented locally on a single PC, connected workstation (i.e. networked LAN) across extended networks such as the Internet or using equipment (RF, microwaves, infrared, photonic, etc.) The above described functional elements are implemented in various computing environments. For example, the present invention may be implemented on a convention IBM PC©, Macintosh©, UNIX©, or equivalent, single, multi-modal (e.g. LAN) or networking system (e.g., Internet, WWW), or Cloud Computing. All programming, GUIs, display panels and data related thereto are stored in computer memory, static or dynamic, and may be retrieved by the user in any of: conventional computer storage, display, and/or hard copy (i.e., printed) formats. The programming of the present invention may be implemented by one of skill the art of programming.

What is claimed is:

1. A method to be performed by a general purpose computer for matching one or more items or services with one or more entities, comprising the steps of:
accessing one or more collections of one or more items or services available for acquisition; and
accessing one or more collections of one or more entities; and
selecting one or more entities of the one or more entities, accessed from the one or more collections of one or more entities, where said selected entities use or consume one or more of said accessed one or more items or services while in the process of outperforming other entities in an activity; and
providing one or more representations of one or more items or services of said accessed one or more items or services, in conjunction with one or more representations of one or more entities of said selected entities.

2. The method of claim 1, wherein the one or more collections of one or more items or services for acquisition includes one or more collections of digital content.

3. The method of claim 2, wherein said one or more collections of digital content include collections of music, video, photographs, images, text, books, games, a contest entry, audio, computer programs, models, designs, patterns, waveforms, diagrams, menus, icons, maps, or directions.

4. The method of claim 1, wherein the one or more collections of one or more items or services for acquisition includes one or more collections of consumables.

5. The method of claim 1, wherein the one or more collections of one or more items or services for acquisition includes one or more collections of physical objects.

6. The method of claim 1, wherein the one or more collections of one or more entities includes social networks, databases, online games, or real-time data sources.

7. The method of claim 1, wherein one or more of said selected one or more entities is an aggregation of other entities.

8. The method of claim 1, wherein said selected entities outperform other entities by said selected entities improving their performance relative to themselves.

9. The method of claim 1, wherein one or more of the selected entities are associated with one or more defined geographic areas.

10. The method of claim 1, wherein one or more of the selected entities are associated to one or more abstract categorizations.

11. The method of claim 1, wherein one or more of the accessed items and services are associated with one or more defined geographic areas.

12. The method of claim 1, wherein one or more of the accessed items and services are associated with one or more abstract categorizations.

13. The method of claim 1, wherein the one or more representations of the one or more items or services, provided in conjunction with the representations of one or more entities, of said selected of entities, consists of one or more depictions of said one or more accessed items or services, and one or more depictions of said one or more selected entities.

14. The method of claim 13, wherein said one or more depictions incorporate one or more of text, images, video, animation, audio, multimedia, data, statistics, rankings, or descriptions.

15. The method of claim 1, further comprising the step of:
providing a method for acquisition of one or more items or services accessed from one or more collections of one or more items or services; and
recording subsequent acquisitions in one or more databases.

16. The method of claim 15, wherein the method of acquisition is the transfer of one or more of the accessed items or services from one or more computer accessible storage devices to one or more computer accessible storage devices.

17. The method of claim 15, wherein the method of acquisition is one or more of purchasing, winning, trading, donation, or gifting

18. The method of claim 15, further comprising the steps of:
providing a method to compensate one or more of the one or more selected entities.

19. The method of claim 15, further comprising the steps of:
performing a mathematical analysis of said recorded acquisitions,
whereby the effectiveness of providing representations of items or services in conjunction with representations of entities who use or consume said items or services while out performing other entities in an activity, can be characterized.

20. The method of claim 15, further comprising the steps of:
making said acquisitions recorded in one or more databases part of the result of a query of acquisitions.
